(19) United States
(12) Patent Application Publication
(10) Pub. No.: US 2003/0001853 A1
(43) Pub. Date: Jan. 2, 2003

(54) Display controller, microcomputer and graphic system

(76) Inventor: Yuji Obayashi, Sayama (JP)

Correspondence Address: Mattingly, Stanger & Malur, P.C., Suite 370, 1800 Diagonal Road, Alexandria, VA, 22314, US

(21) Appl. No.: 10/180,535

(22) Filed: Jun. 27, 2002

(30) Foreign Application Priority Data
May 20, 2002 (JP) 2002-145122
Jul. 2, 2001 (JP) 2001-200616

(51) Int. Cl. G09G 5/36; G06F 12/10; G06F 13/14

(52) U.S. Cl. 345/568; 345/519

(57) ABSTRACT

There is provided a display controller which can execute, with the hardware process, the address conversion corresponding to each drawing format even when a plurality of display data which are different in drawing formats exist simultaneously on the video memory and thereby can simultaneously improve the memory access performance in the drawing process and reduce a load of the CPU. This display controller 1 comprises an input section to which a display data and an address data are inputted, a video memory interface for writing the input display data to a video memory corresponding to a physical address in which each pixel of a 2n×2m (n and m are natural numbers) rectangular area formed by dividing the display area is continuous and a drawing circuit for executing the designated drawing process by receiving a command code for drawing from an external circuit. This display controller is further provided with an address conversion means which can replace the bit arrangements of the address data inputted from an external circuit and also can set the replacing portion for every address ranges.

### BACKGROUND OF THE INVENTION

The present invention relates to a technique which may be effectively applied to a display controller including a drawing function and a technique which may be effectively applied, for example, to a microcomputer in which a CPU and a display controller is integrated on one semiconductor chip.

A certain existing graphic controller having a function to draw a line connecting two points employs a tile address format in which each pixel of a display image and a physical address of a video memory are inter-related to provide a continuous physical address corresponding to a small rectangular area formed, for example, of about 32 horizontal and 32 vertical pixels. For example, when a video memory is structured with an SDRAM (Synchronous Dynamic Random Access Memory), since continuous accesses in the same row address can be executed in a high speed, the drawing process can be completed only with the drawing process in the same row on the occasion of drawing, for example, a thin line by applying the tile address format as explained above. Thereby, the high speed drawing process can be realized.

For example, the Japanese Unexamined Patent Application Publication No. Hei8(1996) -297605 describes a graphic controller which has a drawing function and uses a frame buffer of tile address format. This graphic controller is structured to continuously process, for the 8-bit color/pixel, a physical address of video memory in the rectangular area of 32 horizontal pixels and 16 vertical pixels and to continuously process, for the 16-bit color/pixel, a physical address of video memory in the rectangular area of 16 horizontal pixels and 16 vertical pixels. Namely, capacity of video memory corresponding to one rectangular area is fixed to 512 bytes. Moreover, this graphic controller can change over the width of drawing area to 512 pixels or to 1024 pixels.

Meanwhile, in the ordinary user interface provided in the operating system of a computer, a linear address format using the continuous address for right end from the left end of the drawing area is used in general. Therefore, in the case where a display controller of the tile address format is used in this operating system, the address conversion to the tile address format from the linear address format is required.

For example, the Japanese Unexamined Patent Application Publication No. Hei 8(1996)-50573 discloses, as a second prior art example, a microcomputer for data drawing through address conversion to the tile address format from the linear address format. In this microcomputer, a frame buffer is formed on the main memory but replacement of address bit is conducted on the occasion of making access to the frame buffer from the CPU. This replacement enables process of the address processed with the CPU in the linear address format and the process of display data in the tile address format on the actual frame format.

### SUMMARY OF THE INVENTION

In recent years, the operating system treats a plurality of kinds of drawing area sizes and a plurality of kinds of pixel format, for example, the number of colors and also has a function of the multi-task process to simultaneously execute a plurality of applications. Therefore, a plurality of display data which are different in the size of drawing area and in the pixel format coexist in a certain case on the video memory. Since, the address conversion format to the tile address format from the linear address format is also different when the size and pixel format of the drawing area are different, selection of the more adequate address conversion system with the operating system during access to the display area from the application is necessary to simultaneously process a plurality of display data from the operating system.

However, in the graphic controller of the first prior art example, an image data of the linear address format to be processed by the operating system must be converted to the tile address format which may be displayed with the graphic controller with the drawing function thereof and software process by the CPU and therefore the processing performance of system is suppressed. Moreover, it is now possible to process the frame buffer in the linear address format from the CPU side by replacing the arrangement order of the system bus and the address bus for connecting the graphic controller. However, this method is not practical because a problem that when the address conversion format is set to only one of the 8-bit color/pixel and 16-bit color/pixel because it is usually fixed to one format, the other format is no longer disabled is generated.

Moreover, since the microcomputer of the second prior art example is structured so that the frame buffer area and the other areas are discriminated using a setting value of the memory control register to conduct replacement of address bus only for the frame buffer area, the memory access performance in the drawing process can surely be improved but all drawing processes are processed with the software resulting in a problem that a load of CPU increases and the system process efficiency is lowered when many drawing processes are generated.

It is therefore an object of the present invention to provide a display controller and a microcomputer which enables conversion to the tile address format from the linear address format for a plurality of display data with the hardware process even when a plurality of display data which are different in size of drawing area and pixel format coexist on the video memory and can also improve the memory access performance in the drawing process and reduce a load of the CPU.

The aforementioned and the other objects and novel features of the present invention will becomes apparent from description of the present specification and the accompanying figures.

The typical inventions of the present invention disclosed in the present specification will be outlined as follows.

There is provided a display controller comprising an input panel from which a display data and an address are inputted, a video memory interface for drawing a display data inputted to the video memory corresponding to a physical address for continuous pixels in the 2ⁿ×2^{m} (n and m are natural numbers) rectangular areas formed by dividing the display image and a drawing circuit for receiving a drawing command code from an external circuit to execute the designated drawing process and this display controller is further provided with an address converting means for mutually replacing the bit arrangements of the address inputted from the external circuit and an address conversion setting means for setting the bit portions to be replaced with the address converting means for every range among a plurality of address ranges.

According to such means, even when a plurality of display data which are different in size of drawing area and pixel format coexist on the video memory, the linear address format can be converted respectively to the tile address format corresponding to a plurality of display data with the address conversion setting means and address converting means explained above. Moreover, since the drawing process can be executed by reducing a load of the CPU with the drawing circuit, the memory access performance in the drawing process can be improved and the load of CPU can also be reduced simultaneously.

It is preferable here that the memory area of video memory is divided to a plurality of address ranges to store the display data of the display image which are different for every address range and the address conversion setting means is structured to be capable of setting the replacement part of the bit arrangement for every divided address range.

According to the structure explained above, when a plurality of applications can process the display data which are different in size of drawing area and pixel format, for example, with the parallel processes, replacement of bit arrangement of the adequate address can be realized for each application.

It is more preferable that the address conversion setting means is constituted of a data table in which the predetermined bit among the significant bits of the address indicating the divided address range is defined as the index for extracting the registered data while the bit data for determining the replacement part in the address range as the registered data. owing to such structure, the replacement part of the bit arrangement can be identified quickly from the address range.

Moreover, in the microcomputer of the present invention, the central processing unit to execute the system control process including the drawing process and the display controller explained above are formed on one semiconductor substrate.

There is provided a microcomputer comprising a central processing unit to execute the system control process including the drawing process, a memory management unit to convert a logical address processed with the central processing unit to a physical address of the main memory and a drawing circuit to execute the drawing process designated by receiving a command code for drawing from the central processing unit. Moreover, the memory management unit includes an address converting means which converts, on the occasion of drawing the display data to the video memory corresponding to the physical address for continuous pixels of the 2n×2m (n and m are natural numbers) rectangular areas formed by dividing the display image with the central processing unit, the display data to the physical address of the video memory by mutually replacing the bit arrangements of the logical address supplied from the central processing unit and this memory management unit is further provided with an address conversion setting means which is capable of setting the replacement part of the bit arrangement for every range among a plurality of ranges of the video memory.

According to the structure explained above, since the memory management unit also controls the conversion of address of video memory, the chip area can be reduced by deleting overlap of the similar circuit structure.

Moreover, the graphic system of the present invention comprises a CPU for arithmetic operations, a memory to store a display data and a display to generate a video signal based on the display data of the tile address format. An address converter is provided to convert the linear address format display data to the tile address format data on the access route to the memory from the CPU.

According to such means, the tile address format display data which can be written quickly in many drawing processes can be developed to the memory and the general purpose linear address format display data can also be treated in the CPU side. Therefore, a general purpose OS (operating system) can be applied in the linear address format to an information processor under the control of the CPU and thereby a system and an application can be developed easily in comparison with the case where the exclusive OS is used. In this case, the address converter can determine that the address of display data received should be converted or not and can convert the address as required only by instructing to the register or the like within the address converter whether the data is the linear address format or the tile address format from the CPU side.

In addition, it is also preferable that the address converter is provided with a setting register which can set execution or non-execution of the address conversion (for example, [e] bit of the address conversion method table 81). Thereby, the address conversion is conducted for the linear address format display data, while the data transfer is conducted for the file data of the draw command and tile address format display data without execution of the address conversion.

It is also preferable that the address converter is structured to be capable of executing the address conversion in a plurality of converting systems and thereby the conversion system executed by the address converter is changed based on the predetermined condition. Accordingly, even in the case where the multi-window display is conducted using a plurality of windows of different display image format, different address conversions can be adapted for every display data of each window.

Here, the practical structure to realize above program is that the address conversion system is changed depending on the address range of the video RAM40 to be accessed by setting a value to the 4-bit×236-entry of the address conversion method table 81. Moreover, it is also possible that the conversion system is determined, for example, with a control program executed by the CPU and the conversion method is changed by outputting from the CPU a signal for transferring the conversion system to the address converter.

Moreover, the address converter can also be structured to convert the linear address format to the tile address format by mutually replacing the values in the two bit ranges among the addresses of the display data. In addition, it is also possible to convert the linear address format to the tile address format after the address range is shifted for the predetermined length by executing the address conversion using various algorithms.

It is more preferable that a communication means which assures data reception is provided and the linear address format display data received via the communication means is converted to the tile address format display data and is then developed in the memory explained above and thereby the video signal based on the display data is outputted with the display. Consequently, the drawing process of higher memory access performance can be realized within the inside and the system of high flexibility can be utilized for exchange of display data with the external side in the higher drawing performance system.

### BRIEF DESCRIPTION OF THE DRAWINGS

FIG. 1 is a structural diagram showing an embodiment of a graphic controller to which the present invention can be adapted effectively.

FIG. 2 is a diagram for explaining a relationship between the video memory and CPU for simultaneous display of a plurality of images.

FIG. 3(A) is a diagram showing a structure of pixel block in the window display of FIG. 2.

FIG. 3(B) is a diagram showing a structure of drawing area in the window display of FIG. 2.

FIG. 4 is a diagram for explaining an address conversion method in the window display of FIG. 2.

FIG. 5(A) is a diagram showing a structure of pixel block in the background display of FIG. 2.

FIG. 5(B) is a diagram showing a structure of image area in the background display of FIG. 2.

FIG. 6 is a diagram for explaining the address conversion method in the background display FIG. 2.

FIG. 7 is a diagram showing a detail structure of the address converter of FIG. 1.

FIG. 8 is a structural diagram showing an embodiment of the microcomputer of the present invention.

FIG. 9 is a diagram for explaining the address conversion method by a memory management unit of FIG. 8.

FIG. 10 is a structural diagram of a graphic system as an embodiment of the present invention.

FIG. 11 is a flowchart showing a drawing process of video driver used in the graphic system of the present invention.

FIG. 12 is a flowchart showing an area generating process of the video driver used in the graphic system of the present invention.

FIG. 13 is a diagram showing an information providing service mode using an information processor to which the present invention is applied.

### DETAILED DESCRIPTION OF THE PREFERRED EMBODIMENTS

The preferred embodiments of the present invention will be explained in detail with reference to the accompanying drawings.

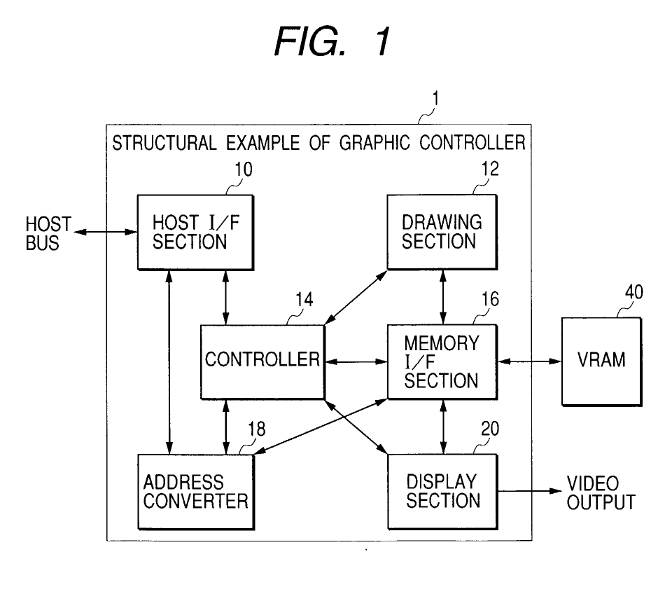

FIG. 1 is a structural diagram showing an embodiment of a graphic controller to which the present invention can be effectively applied.

The graphic controller 1 of this embodiment is structured, although not particularly restricted, to be formed on one semiconductor chip such as a single crystalline silicon. This graphic controller 1 comprises: a host I/F section 10 for inputting and outputting data, for example, from a CPU via a host bus; a drawing section (drawing circuit) 12 to execute the drawing process with a hardware by fetching the data of drawing area of a video RAM40 following an instruction of a controller 14; a controller 14 for instructing the drawing process to the drawing section 12 by controlling the operation of each block and receiving a command code from the CPU; a memory I/F section 16 for drawing or reading display data to or from an external video RAM (Random Access Memory) 40; an address converter 18 for replacing the bit position of the predetermined part of the address inputted from the CPU; and a display section 20 or the like for converting the display data stored in the frame memory of the video RAM 40, for example, to the RGB video signal and then outputting this video signal. The video RAM 40 is, for example, an SDRAM (Synchronous Dynamic RAM) and has the capacity to develop at a time the display data of a plurality of display images.

The drawing section 12 is provided with various drawing functions such as a hardware drawing function to designates two points and to draw the display data connecting such two points with a linear line to the video RAM 40 by inputting the command code for drawing the linear line. Moreover, the drawing section 12 corresponds to the tile address format to realize high speed access for display data to the video RAM 40.

This graphic controller 1 receives various drawing requests from an external side via a driver software but this driver software sorts the request with the drawing section 12 to the requests to be processed and the requests not to be processed and controls the drawing section 12 to execute the process by fetching the requests to be processed. For the requests not to be processed, the driver software executes the drawing process using a software or executes the drawing process from the viewpoint of software using the general purpose standard drawing library offered by the operating system.

Since the general purpose standard drawing library is generated by assuming the pixel layout of linear address format, there is no compatibility with the drawing function of the graphic controller 1 in the present condition. Therefore, such compatibility can be assured through the replacement of the address bit using the address converter 18.

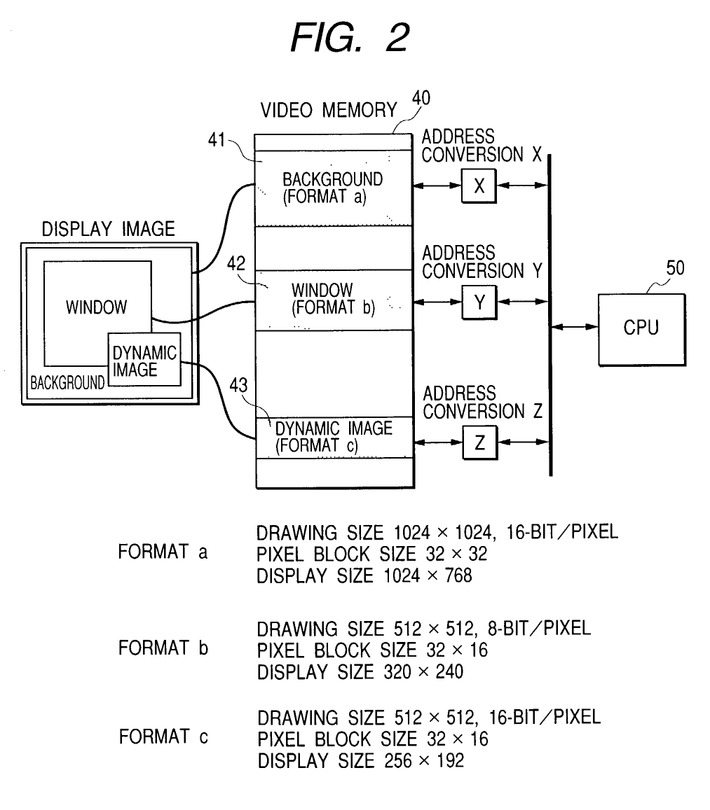

FIG. 2 is a diagram for explaining a relationship between the video RAM and CPU for simultaneous display of a plurality of images in the system loading the graphic controller 1.

The graphic controller 1 is assumed to be installed to a system which can execute in parallel a plurality of applications with the multi-task process. In this system, image displays of a plurality of applications are executed simultaneously on one display image. In the case where a plurality of image displays are conducted, the storage area of video RAM 40 is divided to a plurality of address ranges and the storage area of one address range is assigned to each application. Each application develops the display data in the assigned memory area. Thereafter, the graphic controller 1 reads the data of window size from a plurality of display data, executes the superimposing process, transmitting and semi-transmitting processes based on the alignment on the position of window depending on the priority of display and thereafter converts the data into the RGB video signal and then outputting this video signal. Thereby, a plurality of window images can be displayed on one display image.

In the example of FIG. 2, the image data 41 to 43 of the first to third areas are background images in which the data of the first area, for example, is developed by the operating system, the image data 42 of the second area is the window image of the application and the image data 43 of the third area is the image of dynamic image reproduced by the dynamic image software. These image data have the format which are different in a size of drawing area or in a pixel format, for example, such as color bit. For instance, the display data of the first area 41 is formed of 1024×1024 pixels in the format of 16-bit color/pixel, while the display data of the second area 42 is the 512×512 pixels in the format of 8-bit color/pixel and the data of the third area 43 is the 512×512 pixels in the format of 16-bit color/pixel. Moreover, in the graphic controller 1 of this embodiment, the display data also corresponds to the 1024×1025 pixels in the format of 8-bit color/pixel. In addition, the display size means a window size which is actually displayed on the display image and this window size can be changed freely within the range of the drawing area size.

An address of the video RAM 40 is set in the tile address format. Moreover, a size of the pixel block which is considered as a continuous address is fixed to combination of particular values which are different depending on the size of drawing area and pixel format. In this embodiment, the pixel block as the continuous address, for example, in the 1024×1024 pixels is set to 32×32 pixels, while the pixel block as the continuous address in the 512×512 pixels is set to 32×16 pixels.

The SDRAM forming the video RAM 40 can generally be accessed at a high speed when the row address corresponding to the significant part of address is identical. Therefore, high speed memory access can be realized in various drawing processes by setting the memory capacity of the pixel block to a value smaller than the size of area in which the row address becomes identical in the SDRAM of the video RAM 40. For example, in the case where a short line is drawn in the pixel block #0 at a part of the drawing area, the drawing process is completed only with the drawing to the same row address of the SDRAM corresponding to the relevant pixel block #0. Moreover, similar improvement in the process can be attained in various drawing processes such as the drawing to a small area and the drawing of a vertical line. As a result, the access rate to the video RAM40 can be improved in comparison with that in the linear address format and the drawing process in the short period can also be realized.

According to the structure of the video RAM 40 explained above, when the video RAM40 is accessed from the CPU 50 using the general purpose standard drawing library formed in the linear address format, the normal access can be realized by converting the address of the linear address format outputted from the CPU50 to the tile address format. Moreover, since conversion to the tile address format from the linear address format is different depending on the format of drawing area, different address conversions X, Y, Z are required for every access to the three address ranges. When the drawing process has been conducted through the address conversion, since the video RAM 40 is accessed in the tile address format even in the drawing process using the standard drawing library of the tile address format, the processing rate can be improved in various drawing processes.

Next, the address conversion system for each drawing area will be explained.

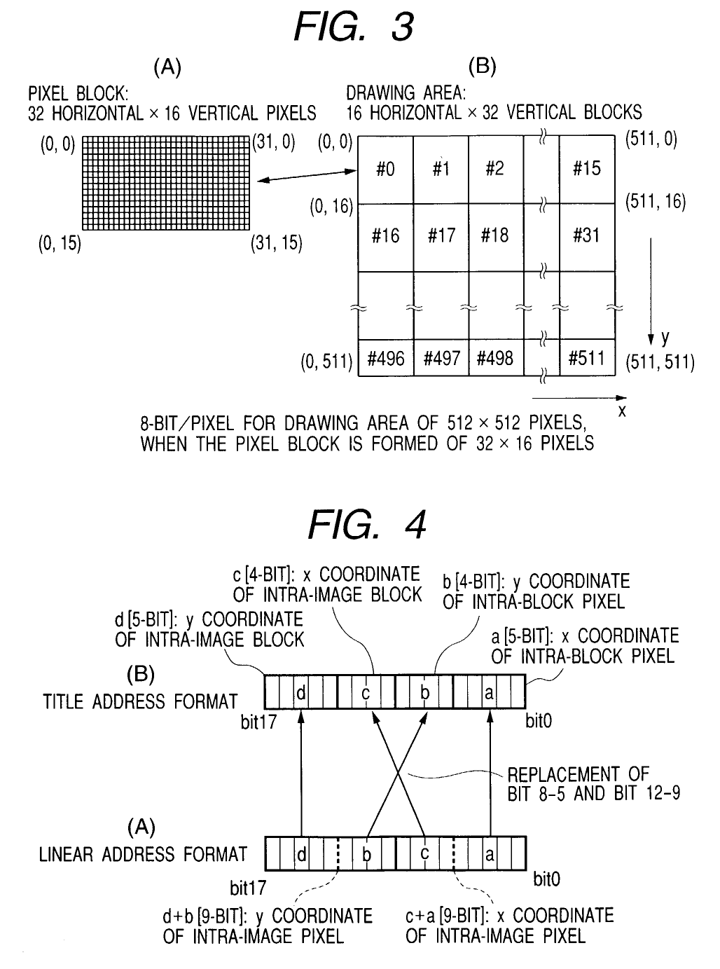

FIG. 3(A) shows an entire structure of the pixel block in the window display of FIG. 2 and FIG. 3(B) shows an entire structure of the drawing area in the window display of FIG. 2.

FIG. 4 is a diagram for explaining the address conversion method in the drawing format b.

In regard to the drawing format of the window display of FIG. 2, the drawing area size is 512×512 pixels of 8-bit color/pixel and the pixel block where the address becomes continuous is formed of 32 horizontal pixels×16 vertical pixels.

In such drawing system, since the entire data capacity of the drawing area is 512×512×8-bit=218 bytes, the address in the drawing area becomes 18-bit data. In the linear address format of (L), the more significant 9-bit [d+b] of address indicates the y coordinate of the drawing plane, while the less significant 9-bit [c+a] indicates the x coordinate of the drawing plane. Moreover, the more significant 5-bit[d] of the more significant 9-bit[d+b] indicates the numbering of pixel block in the y direction of the drawing plane, while less significant 4-bit[b] indicates the y coordinate in the relevant pixel block. Moreover, more significant 4-bit[c] of the less significant 9-bit[c+a] showing the x coordinate indicates the numbering of pixel block in the x direction of the drawing plane, while the less significant 5-bit[a] indicates the x coordinate in the relevant pixel block.

Therefore, in such a structure of the drawing area, conversion to the tile address format of (M) from the linear address format of (L) can be attained by replacing the [c] of 5th to 8th bits with the [b] of the less significant 9th to 12th bits. With such conversion, the more significant 9-bit [d+c] indicates, in the tile address format of (M), the number of the pixel block in the xy directions of the drawing area, while the less significant 9-bit[b+a] indicates the xy coordinates in the relevant pixel block.

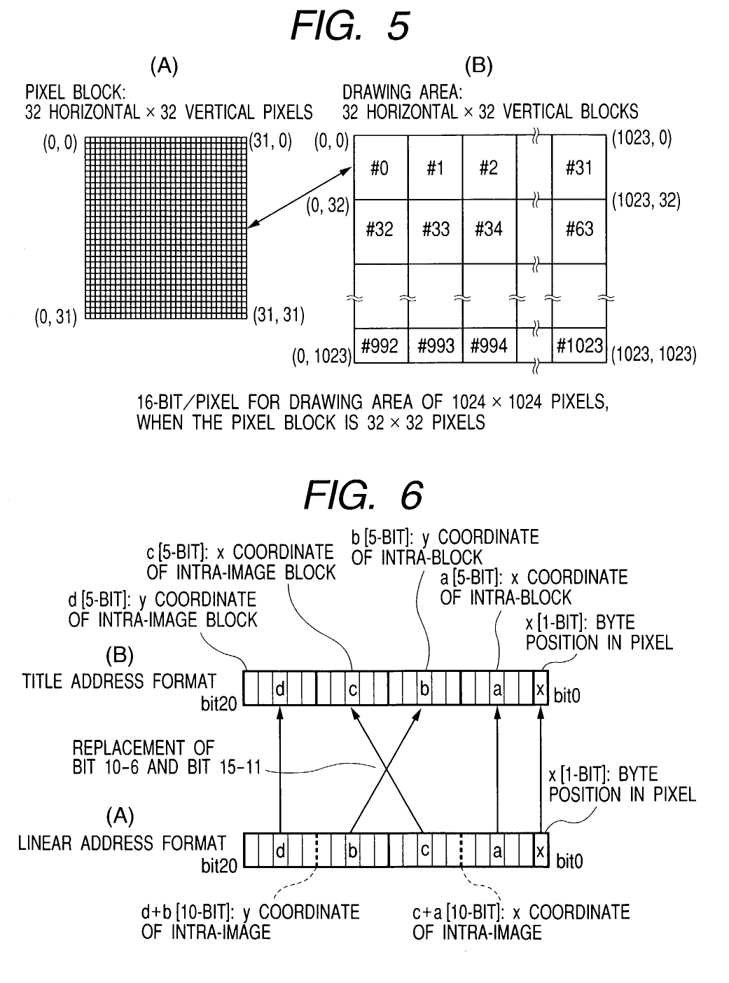

FIG. 5(A) shows the pixel block in the background display of FIG. 2 and FIG. 5(B) shows an entire structure of the drawing area. FIG. 0.4 shows the address conversion system of address in the background display.

In this drawing format of the background display, the drawing area is formed of 1024×1024 pixels in 16-bit color/pixel, while the pixel block in which the address becomes continuous is formed of 32 horizontal pixels×32 vertical pixels. In this case, as an access to the video RAM40, write and read of display data can be realized at a time for one pixel block by making access, for example, to each block data of 2048 bytes with the burst access.

In the case of such drawing format, since the total data capacity of drawing area becomes 1024×1024×16-bit=221 bytes. Therefore, the address becomes 21-bit data as shown in FIG. 6. In the linear address format of (B), the 11th to 20th bits [d+b] of address indicates the y coordinate of the drawing plane, while the 1st to 10th bits [c+a] indicates the x coordinate of the drawing plane and less significant 1 bit [x] indicates the more significant or less significant byte of 16-bit color in one pixel, respectively. The 16th to 20th bits[d] and 6th to 10th bits [c] indicates the numbering of the pixel block in the xy directions of the drawing plane, while 11th to 15th bits [b] and 1st to 5th bits [a] indicate the xy coordinates in the pixel block.

Therefore, conversion to the tile address format of (A) can be attained by replacement of the 11th to 15th bits [b] with the 6th to 10th bits [c].

In the same manner, even in the formats of 1024×1024 pixels, 8-bit color/pixel and 512×512 pixels, 16-bit color/pixel, conversion to the tile address format from the linear address format can be realized by replacement of the predetermined bits of address.

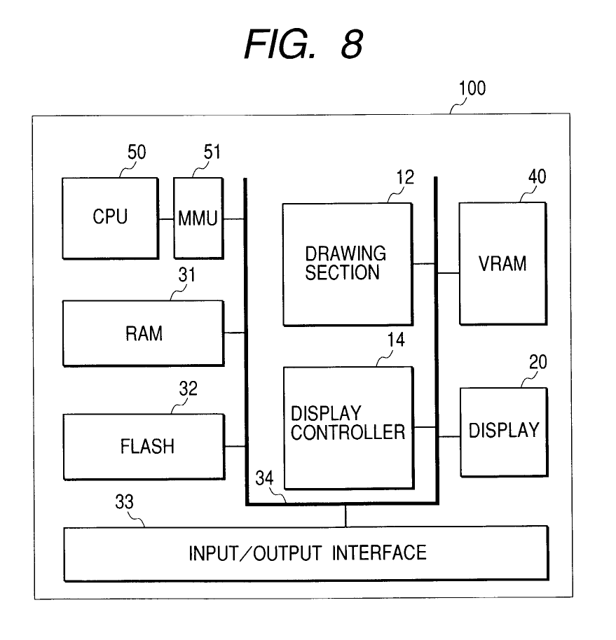

FIG. 8 shows details of the address converter of the graphic controller 1.

The address converter 18 is composed of the barrel shifters s to u and selectors a to f as the address conversion means for executing replacement of bits of address with the hardware, an address conversion method table 81 as an address conversion setting means which can set a method of the address conversion for every address range and a control signal generator 83 for generating a signal to control the replacement of address bits based on the registered data extracted from the address conversion method table.

The address conversion method table 81 is the data table of 4-bit×256-entry and extracts the data of one entry corresponding to the index which is defined with the more significant 8-bit address of the video memory.

The entry data of this address conversion method table 81 is formed as 4-bit data including the bit [e] indicating conversion of address and non-conversion of address, the bit [w] indicating the width of the drawing area whether it is 512 pixels or 1024 pixels, the bit [h] indicating the height of drawing area whether it is 512 pixels or 1024 pixels and the bit [c] indicating the 8-bit color or 16-bit color.

When the drawing area is assigned, for example, to the address range where the more significant 8-bit addresses of the video RAM 40 are “00000100” to “00111111”, the above 4-bit data of [e, w, h, c] indicating the attribute of the drawing area are respectively registered to all entries (from entry #4 to #63) in which the 8-bit value in this range is used as the index. Moreover, in the same manner, when a plurality of drawing areas are assigned to different address ranges, the attribute information of the corresponding drawing area is registered, for each drawing area, to all entries where the 8-bit value in the range of the assigned more significant 8-bit address is defined as the index.

Data registration to the address conversion method table 81 is conducted by respectively inputting, from an external CPU or the like, a select signal SELECT for data registration, an 8-bit address indicating the assigned area and a 4-bit entry data indicating the attribute information of the area when a part of the area of the video RAM 40 is assigned to the application.

The control signal generator 83 generates a control signal to determine the selection of the barrel shifter and selector and then supplies this control signal based on the entry extracted from the address conversion method table. The barrel shifters s to u and selectors a to f input a physical address A [23:0] of 24-bit before conversion inputted from the CPU side, replaces the address bits as required with the control signal from the control signal generator 83 and then outputs the real address MA [23:0] after conversion. Thereby, replacement of four address bits explained above can be executed selectively. Here, A[j:k] means the k-bit to j-bit of the address.

For example, when the replacement of address bit of FIG. 4 (replacement of A[12:9] and A[8:5]) is executed, the barrel shifter s shifts the inputted 7-bit A [15:9] to select A[12:9] as the more significant 4-bit, while the barrel shifter t shifts the inputted 6-bit A[10:5] to select A[8:5] as the less significant 4-bit and the selector a selects an output of the barrel shifter t while the selector b selects an output of the barrel shifter s. Moreover, the selector c selects the A[15] the selector d selects the A[14] and the selector e selects the A[13], respectively.

Since an input of the barrel shifter u is formed by vertically coupling the outputs of the selectors a and b, its value becomes 10 bits of {**,A[8], A[7], A[6], A[5], A[12], A[11], A[10], A[9], **(“**” indicate invalid bits)}. Here, the barrel shifter u selects the 7-bit from the 2nd bit to 8th bit, while the selector f selects the A[9]. Accordingly, the address MA [23:0] in the video RAM 40 side is sequentially indicated from the more significant bits as {A[23:16], A[15], A[14], A[13], A[8:5], A[12:10], A[9], A[4:0]} and thereby the conversion shown in FIG. 4 can be achieved.

Moreover, when the replacement of address bits of FIG. 6 (A[15:11] and A[10:6]) is to be conducted, first, the barrel shifters selects the A[15:11] and the barrel shifter t selects the A[10:6], while the selector a selects an output of the barrel shifter t and the selector b selects an output of the barrel shifter s. Subsequently, the selector c selects the A[10] and the selector d selects the A[9] and the selector e selects the A[8]. Since an output of the barrel shifter u is formed by coupling in vertical the outputs of the selectors a and b, its value becomes 10 bits of {A[10] A[9], A[8], A[7], A[6], A[15], A[14], A[13], A[12], A[10]}. Here, the selector u selects 7 bits from the 4th bit to 10th bit. Thereby, the address MA [23:0] in the video memory side is indicated sequentially from the more significant bits as {A[23:16], A[10], A[9], A[8], A[7:6], A[15:10], A[5] and A[4:0]}. Thereby, the conversion of FIG. 6 has been conducted.

Namely, the address converter 18 of the structure explained above realizes, with the hardware, the conversion of the linear address format treated in the CPU50 to the tile address format as the real address of the video RAM40 and moreover this address conversion method can be selectively set from the four kinds for every drawing area assigned to the video RAM40.

As explained above, according to the graphic controller 1 of this embodiment, since the address conversion to the tile address format from the linear address format can be realized with the hardware depending on each image display format during access to the video RAM40 from the CPU50 even in the system that a plurality of image displays in different size of drawing area and different color bits are performed on one display image and the standard drawing process is conducted in the linear address format with the CPU50, the high speed drawing process can be realized without enhancement of load on the CPU. Moreover, with the access to the video RAM40 in the tile address format, the number of times of access to the video RAM40 in various drawing processes can be reduced and thereby power consumption can be so far reduced.

[Second Embodiment]

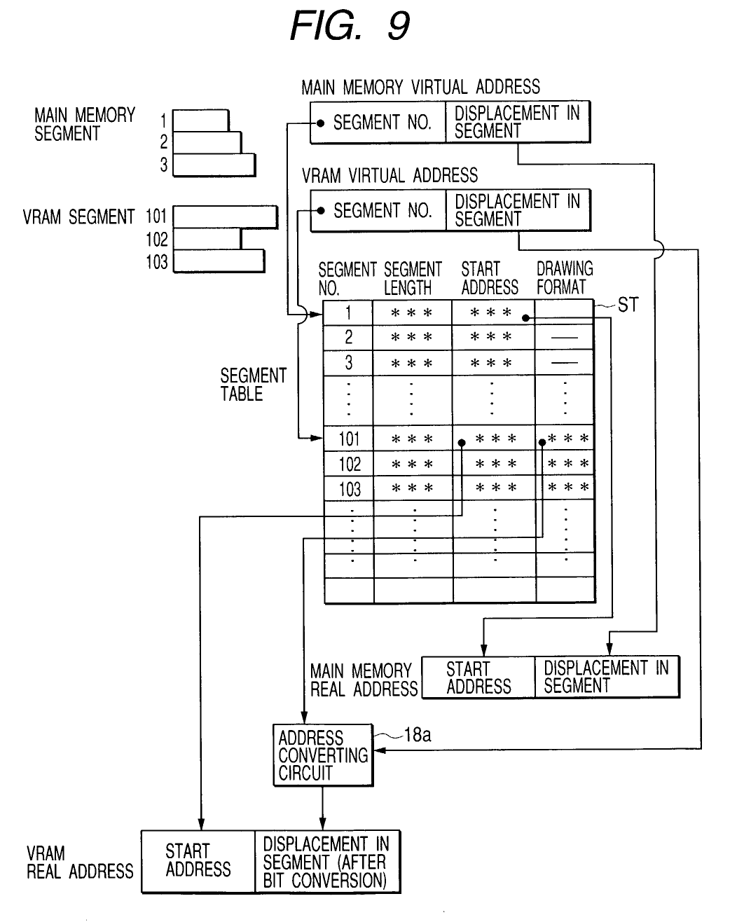

FIG. 8 is a structural diagram showing an embodiment of the microcomputer of the present invention. FIG. 9 is a diagram for explaining an address conversion system by MMU (Memory Management Unit) thereof.

The microcomputer 100 of this embodiment is one chip microcomputer which is formed, although not particularly restricted, on one semiconductor chip such as a single crystalline silicon, comprising: a CPU50 for controlling the entire part of system including the display control; an MMU51 for converting a virtual address processed in the CPU50 to the actual address with the hardware; a flash ROM 32 in which the control program and control data are stored; a RAM31 for providing the work area to the CPU50; an input/output interface 33 for inputting and outputting an external signal; a drawing section 12 shown in the graphic controller 1 of the above embodiment; a controller 14, a display 20; a video RAM40; and a system bus 34 or the like for connecting each unit. The video RAM may be formed in the structure of external circuit or may be integrated with the RAM31.

The MMU51 in this embodiment is, for example, of the segment system in which a part of the area of RAM is assigned independently to the program. Moreover, in this embodiment, this MMU51 is additionally provided with a function to assign the area to the video RAM40 and an address conversion circuit 18a for replacement of the address bit.

The MMU of the segment system is provided, as shown in FIG. 9, with a segment table ST in which the correspondence between the storage area (main storage segment) of RAM assigned independently for each program and the real address is written. Moreover, in this segment table ST, the start address of the drawing area (VRAM segment) of the video RAM40 assigned for each program and the drawing format data indicating the method for replacement of the address bit are registered. Moreover, the MMU51 is provided with the control signal generator 83 shown in FIG. 8 and the address conversion circuit 18a consisting of the barrel shifters s to u and selectors a to f.

According to this structure, when the video RAM40 is accessed from the CPU50, the CPU50 outputs a virtual address (sector number+address in the sector) to the MMU51. Thereby, the start address and the drawing format data indicating the method for replacement of address bit are extracted in the MMU51. A control signal is outputted to the barrel shifters s to u and selectors a to f from the control signal generator 83 of the address conversion circuit 18a based on the drawing format data for the replacement of the predetermined bits for the address in the sector. Here, the start address extracted from the segment table is coupled with the address in the sector after the address conversion to generate the real address of the tile address system. Thereby, the normal access to the video RAM40 can be assured.

As explained above, according to the microcomputer 100, since the area of video RAM40 is assigned and the method of conversion to the tile address format from the linear address format is instructed using the MMU51, the chip area can further be reduced in comparison with the case where the similar structure is provided individually.

[Third Embodiment]

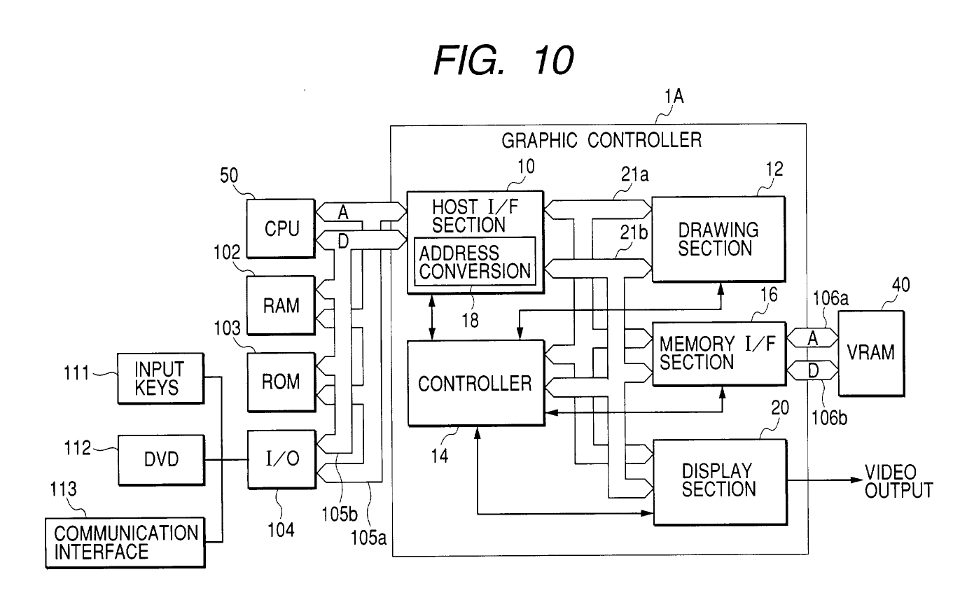

FIG. 10 is a block diagram of an information processor to which the graphic system of the embodiment of the present invention is applied.

In this embodiment, the graphic system of the present invention is adapted to an information processor, for example, a car-navigation system and a PDA (Personal Data Assistant). The information processor comprises: a CPU 50 for totally controlling an apparatus including a drawing process; a RAM102 for providing a memory space for the process in the CPU50; a ROM103 for storing a control program and a control data such as OS (operating system) and application software; an I/O interface 104 for inputting and outputting data to from an external circuit; a video RAM40 for storing display data; a graphic controller 1A provided for exchange of data between the CPU50 and video RAM40 for generating and outputting a video signal based on the display data written to the video RAM40; host buses 105a, 105b for connecting the CPU50, RAM102, ROM103, I/O interface 104 and graphic controller 1A; and memory buses 106a, 106b for connecting the video RAM40 and graphic controller 1A.

Moreover, the I/O interface 104 is connected with an input key 111 for realizing the input manipulation from a user, a large capacity storage device 112 such as DVD drive and a communication interface 113 for realizing data communication through connection with a communication device such as a mobile phone.

Moreover, this information processor is connected with a display not illustrated. A video signal from the graphic controller 1A is outputted to this display and thereby an image is outputted to the display.

The graphic controller 1A comprises the host I/F section 10 for inputting and outputting the data to and from the host buses 105a, 105b, the drawing section 12 which generates, with hardware, the display data of tile address format having the predetermined drawing content depending on the instruction from the controller 14, the controller 14 for controlling the operations of each block and instructing the drawing process to the drawing section 12 by appreciating the drawing command inputted from the host buses 105a, 105b, the memory I/F section 16 for reading and writing the display data and drawing command to the external video RAM 40, the address converter 18 for converting the address of the display data inputted from the CPU50 and the display section 20 for converting the display data stored in the video RAM40, for example, to the RGB video signal and then outputting this video signal, which are respectively connected with the internal buses 21a, 21b used for transfer of display data.

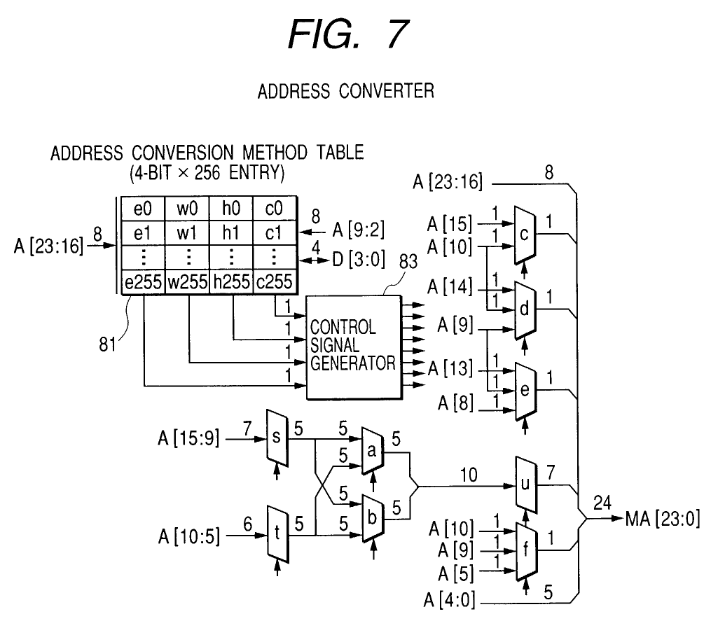

Format of each block in the graphic controller 1A is identical to that of the first embodiment. As explained in the first embodiment, the address converter 18 is structured to select execution/non-execution of the address conversion for every predetermined address range of the video RAM40 depending on the value of the address conversion method table 81 (FIG. 7) as the setting register and to selectively enable a plurality of kinds of address conversion respectively corresponding to a plurality of kinds of window structure in different drawing sizes and number of colors.

As is explained in the first embodiment, as shown in FIG. 7, the address conversion method table 81 is provided with 256 entries respectively assigned for every predetermined address range of the video RAM40. Each entry includes the bit [e] indicating execution or non-execution of the address conversion, the bit [w] indicating whether the width of the drawing area is 512 pixels or 1024 pixels, the bit [h] indicating whether the height of drawing area whether is 512 pixels or 1024 pixels and the bit [c] indicating 8-bit color or 16-bit color. When one window is opened, the area of video RAM40 is assigned to develop the display data of such window and the value indicating the address conversion method applied to the display data of this window is set to the entry of the address conversion method table 81 corresponding to this area. Thereby, as shown in FIG. 2, when the developed area of the display data of each window is accessed from the CPU50, the address conversion is adapted depending on the display format of each window.

It is also possible that the conversion system is determined with a control program which is executed, for example, by the CPU50 without use of the address conversion method table 81 and the address conversion system in the address converter 18 is changed by outputting a signal to instruct the conversion system from the CPU50.

The OS (operating system) operating in the information processor explained above is a general purpose OS and the display data is formed for the process in the linear address format corresponding to the address where the pixel data are continuous in the line direction to the right end from the left end of the display image. The OS may be stored in the ROM103 and also in a PC card type storage device, for example, connected to the I/O interface 104. It is also possible to execute this OS with the CPU50.

Moreover, this OS is formed to open a plurality of windows in one display image with the window function of GUI (Graphical User Interface) and to execute, for each window, the image display with the setting of different colors based on the multi-task process. In the case where a plurality of windows are opened, one memory area of the video RAM40 is assigned to each window and moreover the setting of the address conversion method table 81 of the graphic controller 1A is also conducted, on the occasion of area assigning, to realize the address conversion depending on the window format when the CPU50 writes the display data to the video RAM40. Here, it is also possible to set that the assigning of these memory areas and setting of the table for programming the address conversion system are conducted with a driver software (hereinafter, referred to as a video driver) of the graphic controller 1A executed by the CPU50 based on the request from the OS.

In addition, the application program issues, for example, a drawing command to draw the data in the predetermined shape to the designated coordinates or to execute, when such drawing command is received from the external circuit, the drawing process with the video driver which is executed when the OS transfers the drawing command thereto or with the graphic controller 1A.

Next, the process sequence of the video driver which is realized with the software process by the CPU50 will be explained in detail.

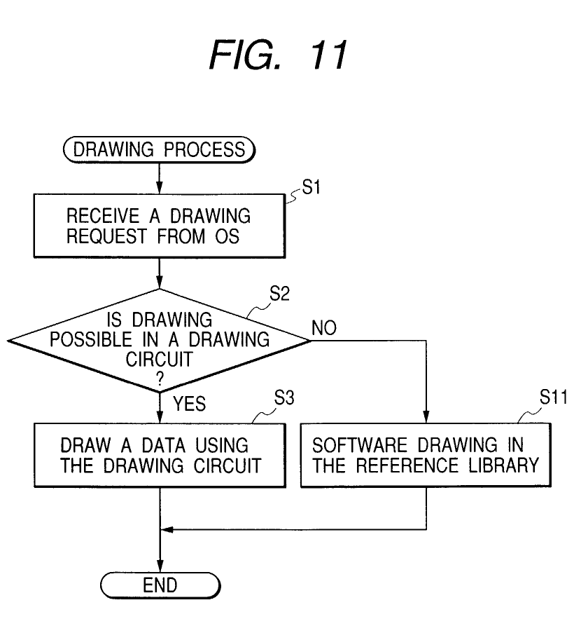

FIG. 11 shows a flowchart of the drawing process which is executed with the video driver.

This drawing process is started in the timing that a drawing command is transferred to the video driver from the OS when the drawing command is issued by the application software and when an instruction to start the drawing process is issued on the basis of the received drawing command (step S1).

Upon reception of the drawing command, the video driver determines whether the drawing command can be covered with the drawing process of the drawing section 12 or not (step S2). When this drawing command can be covered, the video driver controls the drawing section 12 to execute the drawing process to write the display data to the designated area of the video RAM40 (step S3) The drawing section 12 generates the display data of the tile address format and then writes this display data in direct to the video RAM40.

On the other hand, if the drawing command is not covered with the drawing section 12, the drawing is conducted with the software process by the CPU50 using the general purpose standard drawing library offered from the OS and thereby the display data is written to the designated area of the video RAM40 from the CPU50 (step S4). The general purpose standard drawing library processes the display data in the linear address format but this display data is converted to the tile address format with the address converter 18 when it is written into the video RAM40 from the CPU50.

When the process of the step S3 or S4 is completed, this drawing process stops until the next drawing command is transferred. A series of drawing process is executed by repetition of such drawing processes for the number of times as much as the number of drawing commands.

A general purpose drawing command can be received from an external side through the drawing process by the video driver and the load of CPU due to the drawing process can be reduced through the process of the drawing section 12.

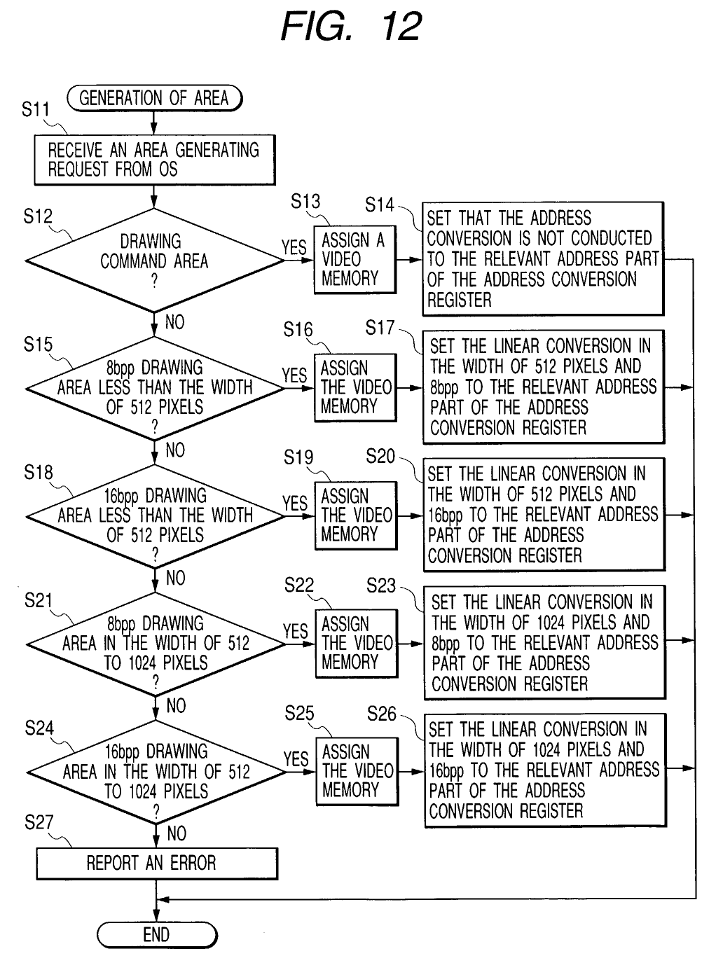

FIG. 12 shows a flowchart of the area generation process to be executed by the video driver.

This area generation process is started (step S11) in the timing that a request of window display (including the display of background) is issued to the OS from the application program when an application program is driven or when it is requested to execute the display of different pieces of information in one application and a request for area generation of the video RAM40 corresponding to this window display is transmitted to the video driver from the OS based on such request of window display. To this area generation request, an information indicating a window format (number of horizontal and vertical pixels of the window and number of colors) is also added.

Moreover, this area generation process is also started when a request to generate the storage area of the drawing command is transferred to the video driver from the OS in such a case that a data file including many drawing commands is generated or inputted due to the reception of the application program and data (step S11).

The video driver determines, when it has received an area generation request, whether the requested area is the storage area of the drawing command or not (step S12) and also determines, when the requested area is a display data development area, the display format of the drawing area such as the number of pixels and number of colors thereof (steps S15, S18, S21, S24). In the flowchart of FIG. 12, determination of the number of pixels in the vertical direction of the window image and setting thereof are omitted and only the determination of the number of pixels in the horizontal direction and setting thereof are indicated.

When the corresponding contents are found as a result of above determination processes, the memory assignment (steps S13, S16, S19, S22, S25) depending on such contents and the setting of the address conversion method table 81 (steps S14, S17, S20, S23, S26) are conducted. Meanwhile, if the corresponding contents are not found as a result of above determination processes, an error is reported to the OS (step S27) and this area generation process comes to the end.

The memory assignment in the steps S13, S16, S19, S22 and S25 is executed by reserving a memory area of the size enough for drawing from the vacant areas of the video RAM40. The video driver processes each area of the video RAM40 corresponding to each entry of the address conversion method table 81 as one unit and reserves a plurality of areas of one unit for the purpose of memory assignment.

Setting in the steps S14, S17, S20, S23, S26 is executed by writing a storing data or a value corresponding to the window format to each entry of the address conversion method table 81 corresponding to the assigned memory area. Namely, in the case of the drawing command storage area, since the address conversion is not conducted, the value “0” is set to the [e] bit, while the desired value to the other bits (step S14).

Moreover, in the case of the display data storage area in the window format in the width of 512 pixels or less of 8-bit color, the value “1” is set to the [e] bit indicating conversion/non-conversion of address, “0” to the [w] bit indicating the width of the drawing area and “0” to the [c] bit indicating the number of colors (step S17). The setting values are changed depending on difference of window format in the steps S20, S23, S26.

When the memory assignment and setting of the address conversion method table 81 are completed, this area generation process stops to wait for the generation of the next area generation.

Even in the case of displaying a plurality of windows of different image formats with such video driver, the display data of the tile address format having higher memory access performance is developed in the video RAM40, while the display data can be processed in the OS side in the linear address format having higher flexibility.

As explained above, according to the information processor loading the graphic system of this embodiment, since the display data of the tile address format is developed in the video RAM40, the high speed process and low power consumption can be realized in the drawing section 12 provided in the graphic controller 1A and in the drawing process by the CPU50. Moreover, since the display data is converted to the tile address format from the linear address format with the hardware process in the address converter 18 of the graphic controller 1A on the occasion of writing the data into the video RAM40 from the CPU50, the display data is processed, in the video RAM40 side, in the tile address format which enables high speed drawing process, while the display data is processed, in the CPU50 side, in the linear address format which assures high flexibility.

Moreover, since the address conversion system can be selectively set from various systems depending on the address range of the video RAM40, even when a plurality of windows are displayed in one image in different image formats such as various window widths and number of colors, the address conversion can be set depending on each window format. Therefore, even when a plurality of windows are displayed in different image formats, the data can be stored in the video RAM40 as the display data of the tile address format which enables high speed drawing process, while the linear address format assuring the high flexibility is processed in the CPU50 side.

In addition, since execution/non-execution of the address conversion can also be set depending on the address range of the video RAM40, when the drawing command is stored to the video RAM40, for example, with the file input or the like, the data can be written in direct to the video RAM40 from the CPU50 without execution of the address conversion.

Therefore, the information processor loading the graphic system of this embodiment is capable of applying the general purpose OS to process the image data in the linear address format and can also use the graphic function using the standard API (Application Programming Interface) provided to the general purpose OS. Therefore, an application software can also be generated easily.

Next, the information providing system utilizing the information processor explained above will be explained.

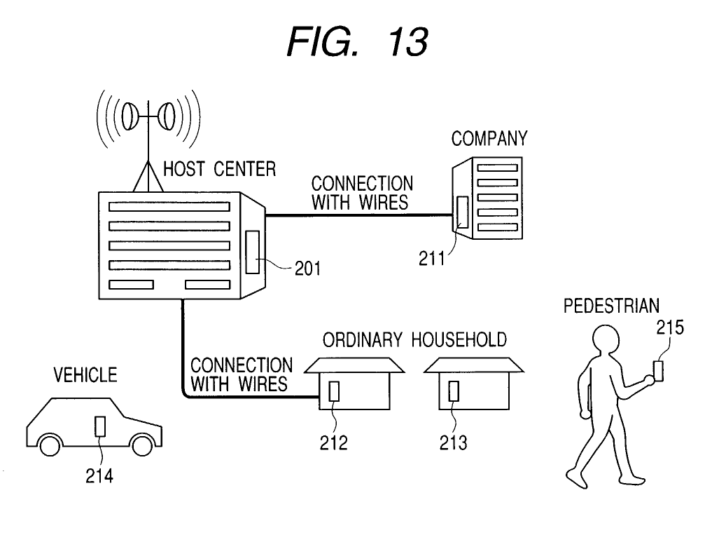

FIG. 13 shows a total structure of the information providing system.

This information providing system is composed of a host computer 201 which is installed in the host center to totally control the information providing system, terminals 211 to 213 such as set top-boxes which are installed at a company or an ordinary household and are connected to the host computer 201 by wire or a radio-link, a car-navigation system 214 which is loaded to a vehicle and is connected to the host computer 201 by the radio-link and a PDA (Personal Digital Assistant) 215 which includes the communication function and can be connected to the host computer 201 by the radio-link. Each information processor is provided with the graphic system illustrated in FIG. 10 explained above.

Various services can be provided to subscribers having installed the information processors through provision, collection and management of information depending on the requests from the terminals 211 to 213 as the information processor, car-navigation system 214 and PDA 215 or the like.

The services intended to the car-navigation system 214 in the information providing system explained above include, for example, the personal services for providing a road navigation information, an information for settlement of charges at a toll road and a drive-through shop and a driving information for collection and management such as an information of shops near the current position, the distribution services such as for providing an information for control of distribution route and management of stock information or the services for providing an information for ordinary businesses.

The services intended to the PDA 215 include a navigation service for pedestrians to display the details of information of buildings and underground shopping areas.

The services intended to the terminals 212, 213 which are installed at ordinary households include, for example, distribution of video data and audio data and provision of traffic information in cooperation with the car-navigation system 214 and PDA. The video data and audio data are converted to a video/audio signal in the terminals 212, 213 and are outputted as the video/audio output to a television receiver.

The services intended to the terminal 211 installed in a company include the service to provide a business support information in cooperation with the service provided to the car-navigation system 214 loaded to a business vehicle and with the PDA215 carried by an employee and to provide a traffic information within the company such as a positional information of an employee.

In this information providing system, since the information processors 211 to 215 are provided with the graphic system of FIG. 1, the memory access performance can be improved in many drawing processes through the display control in the tile address format and the drawing process can also be improved even when the system is operated with the clock of the frequency which is not so high. For the apparatus such as PDA 215 which is requested to show lower power consumption, it is very effective that the high drawing performance can be obtained with the operation clock of lower frequency.

Moreover, since the CPU50 is capable of dealing with the image data in the flexible linear address format, the information processors 211 to 215 can use the flexible linear address format data as the image data offered from the host computer 201.

Therefore, since the general purpose OS which can process the image data in the linear address format can be used for the host computer 201 and information processors 211 to 215 and the graphics function can also be used by introducing the standard API provided to the general purpose OF, the application software for various services can be developed more easily in comparison with novel formation of the exclusive OS.

A drawing command in small amount of data may be used for offering image information to the information processors 211 to 215 from the host computer 102, but the graphic system loaded to each information processor 211 to 215 is provided with a drawing section 12 to execute image process in the tile map format. Therefore it is possible to share the processes. Namely, the drawing section 12 processes the drawing commands when it is possible and the CPU50 processes only the drawing commands which cannot be processed with the drawing section 12. Accordingly, a processing load of the CPU50 can be reduced even in the case of executing the drawing process using the standard drawing command.

Moreover, it is also possible that when the drawing command has been transmitted, setting of the address conversion to the area to store the drawing command is disabled and this drawing command is once stored in the desired area of the video RAM40 to execute later the drawing process with the drawing section 12 and CPU50.

The present invention has been explained above on the basis of the preferred embodiments but the present invention is not limited only above embodiments and naturally allows various changes and modifications not departing from the scope of the claims thereof.

For example, the graphic controller 1 of the embodiment sets the address conversion method for every address range using the address conversion method table in which the data indicating the address conversion method is defined as the entry data using the more significant bits of the address as the index. Moreover, the graphic controller 1 is also capable of determining the address conversion method within the relevant access range with reference to a register value when the access request to the video RM is issued by registering to the register, upon assignment of the video RAM area to the application, the address range of such area (for example, start address and capacity or the like) and the data for determining the address conversion method in such area. In this case, the address conversion setting means is structured with the register explained above.

In addition, various modifications are possible for the kind of pixel format such as size and color bits of drawing area assigned to the application. The structure in above embodiment in which the width and height of the pixel block in the tile address format fixed for every pixel format can be changed with the setting can improve the performance by changing the setting to accommodate the drawing having comparatively higher execution frequency to a less number of pixel blocks.

Moreover, as the address conversion system, a system for mutually replacing the values of two ranges of address has been indicated in the embodiment, but it is also possible to convert the linear address format to the tile address format after the address range is shifted for the predetermined length using various algorithms.

The present invention has been explained above in relation to a one-chip graphic controller and a microcomputer which is an application field as the background of the invention, but the present invention is not limited thereto and can be widely used various apparatuses for the display control.

The effects of the typical inventions disclosed in this specification will be explained below briefly.

Namely, according to the present invention, even when a plurality of display data of different drawing area sizes and pixel formats exist simultaneously on the video memory, the linear address format can be converted to the tile address format with the hardware process corresponding to a plurality of display data. Therefore, the present invention also provide the effect that improvement of access performance to the video memory in the drawing process and reduction of load of CPU can be attained simultaneously.

Moreover, according to the information processor loading the video system of the present invention, the application software can be developed easily, in addition to the effect explained above, for example, the graphics function can be realized using the standard API because the general purpose OS for processing the display data of the linear address format can be adapted to the information processor.

Moreover, the display controller and video system of the present invention can also provide the effect that the memory can be used effectively, namely the file data of the drawing command, for example, can be stored temporarily to the memory without address conversion because it is possible to set non-address-conversion for the address range designated on the memory, for example, of video RAM or the like.

What is claimed is:

1. A display controller comprising: an input section to which a display data and an address are inputted; a video memory interface for writing said input display data to a video memory corresponding to a physical address in which each pixel in a 2n×2m (n and m are natural numbers) rectangular area formed by dividing the display area is continuous; and a drawing circuit for executing the designated drawing process by receiving a command code for drawing operation from an external circuit, wherein said display controller further comprising:
an address conversion means for mutually replacing the bit arrangement of said address inputted from the external circuit; and
an address conversion setting means for setting the bit portions which are replaced with said address conversion means for every address ranges.

2. A display controller according to claim 1,
wherein the storage area of said video memory is divided into a plurality of address ranges and the display data of different images are stored for every address range, and
wherein said address conversion setting means is structured to be able to set the replacement portion of the bit arrangement for every divided address range.

3. A display controller according to claim 2, wherein said address conversion setting means is a data table in which the predetermined more significant bits of the address indicating the divided address range are defined as the index to extract the registered data and the bit data for determining the replacing portion in said address range is set as the registered data.

4. A microcomputer in which a central processing unit to execute the system control process including the drawing process and the display controller according to claim 3 are formed on one semiconductor substrate.

5. A microcomputer comprising: a central processing unit for executing the system control process including the drawing process; a memory management unit for converting a logical address processed with said central processing unit to a physical address in the main memory; and a drawing circuit for executing the designated drawing process by receiving a command code for the drawing from said central processing unit,
wherein said memory management unit includes an address conversion means for converting a logical address to a physical address of the video memory by mutually replacing the bit arrangements of the logical address supplied from said central processing unit when said central processing unit writes the display data to the video memory corresponding to the physical address in which each pixel of a 2n×2m (n and m are natural numbers) rectangular area formed by dividing the display area is continuous and is also provided with an address conversion setting means which can set the replacing portion of bit arrangement for every address ranges of the video memory.

6. A graphic system comprising: a CPU to execute the arithmetic processes; a memory to store a display data; and a display of the tile address format for reading, from said memory, the display data of tile address format corresponding to the address in which the pixel data in each rectangular area formed by dividing the display area in the horizontal and vertical directions is continuous and then generating a video signal which can be outputted from the display,
wherein said graphic system is further provided with an address converter for converting the display data of linear address format corresponding to the address in which the pixel data arranged in the line direction to the right end from the left end of the display area on the access route to said memory from said CPU into the data of tile address format through the address conversion.

7. A graphic system according to claim 6, wherein said address converter is provided with a setting register which is capable of setting execution or non-execution of address conversion of said address converter.

8. A graphic system according to claim 7, wherein said address converter is capable of executing the address conversion with a plurality of conversion systems, the conversion system to be adapted can be changed on the basis of the predetermined conditions, and said predetermined condition can be changed by the setting.

9. A graphic system according to claim 8, wherein said address converter is structured to convert said linear address format to said tile address format by mutual replacement of the values of two bit ranges among the address of the display data.

10. A graphic system according to claim 9, wherein a communication means which enables reception of data is provided, the display data of the linear address format received via said communication means is converted to the display data of tile address format and is then developed on said memory and the video signal based on said display data is outputted by said display section.
